(19) United States
(12) Patent Application Publication
(10) Pub. No.: US 2008/0130474 A1
(43) Pub. Date: Jun. 5, 2008

(54) Optical Recording Materials Having High Stroage Density

(76) Inventors: Beat Schmidhalter, Bubendorf (CH); John S. Zambounis, Bottmingen (CH); Heinz Wolleb, Fehren (CH); Annemarie Wolleb, Fehren (CH); Frank Bienewald, Hegenheim (FR); Jean-Luc Budry, Rossemaison (CH); Heinz Spahni, Frenkendorf (CH)

Correspondence Address: JoAnn Villamizar;Ciba Corporation/Patent Department, 540 White Plains Road, P.O. Box 2005, Tarrytown, NY, 10591, US

(21) Appl. No.: 10/561,392

(22) PCT Filed: Jun. 25, 2004
(86) PCT No.: PCT/EP04/51256

§ 371 Date: Dec. 19, 2005

(30) Foreign Application Priority Data
Jun. 27, 2003 (CH) 2003 1137/03

(51) Int. Cl. G11B 7/24; B32B 3/02

(52) U.S. Cl. 369/275.1; 428/64.4

(57) ABSTRACT

The invention relates to an optical recording medium comprising a substrate, a recording layer and optionally one or more reflecting layers, wherein the recording layer comprises a compound of formula (I). For the detailed definitions of the further substituents, see the description. Recording and playback are effected especially at a wavelength of from 300 to 500 nm, for example using a blue laser. The recording and playback quality is excellent and allows a high storage density even at high speeds.

The invention relates to novel optical recording materials that have excellent recording and playback quality especially at a wavelength of 300-500 nm. Recording and playback can be effected very advantageously with high sensitivity and at high speed, and the storage density that is achievable is significantly higher than in the case of known materials. In addition, the materials according to the invention have very good storage properties before and after recording, even under especially harsh conditions, such as exposure to sunlight or fluorescent lighting, heat and/or high humidity. In addition, their manufacture is simple and readily reproducible using customary coating processes, such as spin-coating.

Research Disclosure 42892 (12/1999, 1649-1651) proposes the use of latent pigments, including phthalocyanines, for optical storage media, but gives no details relating to such optical storage media.

WO 02/25 648, EP 1 253 586, EP 1 265 233 and EP 1 271 500 disclose optical recording materials that comprise inter alia sulfamoyl-substituted phthalocyanines (e.g. Orasol® Blue GN, Ciba Spezialitätenchemie AG) and which can be used at from 300 to 450 nm. Their optical properties, especially the refractive index as well as the absorption and the steepness of the absorption band on its long wavelength flank in the solid, still leave something to be desired.

Many systems that use dyes from other chemical classes, for example merocyanines, are also known. Generally, however, such systems have insufficient stability with respect to thermo-oxidative ageing and/or especially with respect to visible light and the effects of weathering.

Previous optical recording materials suitable for the wavelength range of from 300 to 500 nm therefore satisfy high demands in respect of storage density per unit area, recording speed and stability only to some extent or do not satisfy all such demands to an entirely satisfactory degree at the same time.

EP 0519395 discloses optical recording materials which comprise carbonamide- and sulfonamide-substituted phthalocyanines and which can be used at 785 nm, but their sensitivity and mark accuracy are unsatisfactory.

JP 05/177 949A, WO 02/25 205 and WO 02/080 162 disclose optical recording materials which comprise specific silicon, tin and cobalt phthalocyanines and which can be used at from 750 to 810 nm. Those phthalocyanines can be substituted inter alia also by carbamoyl. Although the definitions of R₇ and R₈ in WO 02/25205 and WO 02/080162 are contradictory, they nevertheless clearly do not include sulfonhydrazides. The storage density of those media is, however, unsatisfactory in terms of the laser wavelength for current and future requirements.

On the other hand, GB-1 265 842 describes the use of phthalocyanine-sulfonhydrazides as antihalation dyes for the red-sensitive layer of silver-halide-containing colour-photographic materials. PL 48087 discloses phthalocyanine-sulfohydrazide derivatives wherein the sulfohydrazide is further substituted by aromatic groups, for example by 1-phenylene-3-methyl-5-pyrazolone.

The aim of the invention is an optical recording medium having high information density, high sensitivity and a high recording and playback speed at 300-450 nm as well as high data reliability. Such a recording medium should be robust, durable and easy to use. Furthermore, it should be inexpensive to manufacture as a mass-produced product and should require equipment that is as small and inexpensive as possible.

The invention relates to an optical recording medium comprising a substrate, a recording layer and optionally one or more reflecting layers, wherein the recording layer comprises a compound of formula

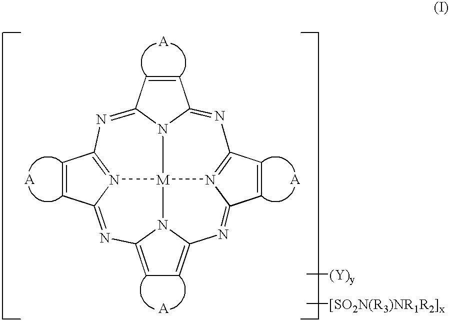

wherein
M denotes 2 hydrogen atoms or a 2- to 4-valent metal which can optionally be coordinated or bonded to 1 or 2 additional ligands;
each A independently of the others is an unsaturated divalent radical which may be unsubstituted or mono- or poly-substituted by Y and/or by SO₂N(R₃)NR₁R₂ and together with the two carbon atoms of the fused-on porphyrazine moiety forms an aromatic homo- or N-hetero-cyclic ring system;
each Y independently of all others is halogen, R₄, OH, OR₄, SR₄, NO₂, NR₄R₅, O—CO—R₄, NR₄—CO—R₅, CN, COOR₄, CONHR₄, CONR₄R₆, CO—R₄, SO₂R₄, SO₂NH₂, SO₂NHR₄, SO₂NR₄R₅, P(═O)R₄R₅, PO(R₄)OR₅, PO(OR₄)OR₅, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₇;
R₁ is hydrogen, COOR₄, CONHR₄, CONR₄R₅, CO—R₄, SO₂R₄, P(═O)R₄R₅, PO(R₄)OR₅, PO(OR₄)OR₅, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₇;
R₂ and R₃ are each independently of the other hydrogen or R₈;
R₄, R₅ and R₈ are each independently of the others C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₇;
R₆ is halogen, hydroxy, O—R₉, O—CO—R₉, S—R₉, CO—R⁹, cyano, carboxy, carbamoyl, COO—R⁹, CONH—R⁹, CONR₉R₁₀, SO₂R₉ or SO₃R₉;
R₇ is halogen, nitro, cyano, hydroxy, R₁₁, C(R₁₂)═CR₁₃R₁₄, O—CO—R₁₅, formyl, NR₁₅R₁₆, CONH₂, CONHR₁₅, CONR₁₅R₁₆, SO₂R₁₅, SO₂NH₂, SO₂NHR₁₅, SO₂NR₁₅R₁₆, COOH, COOR₁₅, OCOOR₁₅, NHCOR₁₅, NR₁₅COR₁₇, NHCOOR₁₅, NR₁₅COOR₁₇, P(═O)R₁₅R₁₇, P(═O)R₁₅OR₁₇, P(═O)OR₁₅OR₁₇, or C₁-C₁₂alkyl, C₃-C₁₂cycloalkyl, C₂-C₁₂alkenyl, C₃-C₁₂cycloalkenyl, C₁-C₁₂alkylthio, C₃-C₁₂cycloalkylthio, C₂-C₁₂alkenylthio, C₃-C₁₂cycloalkenylthio, C₁-C₁₂alkoxy, C₃-C₁₂cycloalkoxy, C₂-C₁₂alkenyloxy or C₃-C₁₂cycloalkenyloxy each unsubstituted or substituted by one or more, where applicable identical or different, radicals R₆;
R₉ and R₁₀ are each independently of the other C₁-C₁₂alkyl, C₃-C₁₂cycloalkyl, C₂-C₁₂alkenyl, C₃-C₁₂cycloalkenyl, C₆-C₁₄aryl, C₄-C₁₂heteroaryl, C₇-C₁₈aralkyl or C₅-C₁₆heteroaralkyl; or
R₉ and R₁₀ together with the common N are pyrrolidine, piperidine, piperazine or morpholine each unsubstituted or mono- to tetra-substituted by C₁-C₄alkyl;
R₁₁ is C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₁₈;
R₁₂ is hydrogen, cyano, halogen, nitro, or C₁-C₁₂alkyl, C₃-C₁₂cycloalkyl, C₁-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₆ and/or by nitro;
R₁₃ and R₁₄ are each independently of the other NR₁₅R₁₆, CN, CONH₂, CONHR₁₅, CONR₁₅R₁₆ or COOR₁₆;
R₁₅, R₁₆ and R₁₇ are each independently of the others R₁₁, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals; or
R₁₅ and R₁₆ together with the common N are pyrrolidine, piperidine, piperazine or morpholine each unsubstituted or mono- to tetra-substituted by C₁-C₄alkyl; or carbazole, phenoxazine or phenothiazine each unsubstituted or substituted by one or more, where applicable identical or different, radicals R₁₈;
R₁₈ is nitro, SO₂NHR₉, SO₂NR₉R₁₀, or C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each substituted by one or more, where applicable identical or different, radicals R₆; and
x is a number from 1 to 8, preferably from 2 to 4, and y is a number from 0 to 15, the sum x+y being a number from 1 to 16;
wherein from 2 to 10 identical or different radicals of formula (I) can be bonded to one another by one or more additional bonds between two or more identical or different R₁, R₂, R₃ or Y, so that dimers, trimers or oligomers having from 4 to 10 phthalocyanine units are formed.

When a plurality of radicals has the same symbol R₁ to R₁₈, the meaning of each radical R₁ to R₁₈ can be independent of all other radicals having the same symbol. For example, Y can be OR₄ and at the same time R₁ can be COOR₄, but R₄ in OR₄ may denote phenyl while R₄ in COOR₄ denotes tert-butyl.

Metals are, for example, alkaline earth metals, such as Mg(II), Ca(II) and Sr(II), transition metals, such as Mn(II), Fe(II), Co(II), Ni(II), Cu(H), Zn(II), Ru(II), Rh(II), Re(II), Pd(II), Cd(II), Os(II) and Pt(II), or some elements of groups XIII, XIV and XV, such as Sn(II), Co(II) or Pb(II). With oxygen as ligand, further examples include Al(III)OH, Ti(IV)O, V(IV)O, Cr(III)OH, Mn(IV)O, Fe(III)OH, Zr(IV)O, Zr(IV)(OH)₂, Si(IV)(OH)₂, Si(IV)(Oalkyl)₂, Rh(IV)(O) and Bi(III)OH, and with halogen as ligand Al(III)Cl, Fe(III)Cl, In(I)Cl, Ce(I)Cl and Si(IV)Cl₂.

A is, for example, a radical

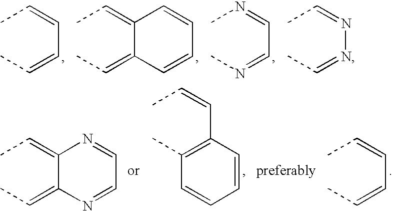

N-Heterocyclic ring systems generally contain from 1 to 4 N atoms, usually 1, 2 or 3 N atoms.

Metals coordinated or bonded to ligands are, for example, Fe(—Cl), V(═O) and those metal/ligand combinations disclosed in JP 05/177 949A, WO 02/25205 and WO 02/080 162 or WO 03/042 990. Further ligands are, for example, amines, such as NH₃ or N-heterocycles, or inorganic, organic or organometallic anions, for example anions of mineral acids, conjugate bases of organic acids (for example an alcoholate, phenolate, carboxylate, sulfonate or phosphonate) or organometallic complex anions, for example fluoride, chloride, bromide, iodide, perchlorate, periodate, nitrate, hydrogen carbonate, ½ carbonate, ½ sulfate, C₁-C₄alkyl sulfate, hydrogen sulfate, ⅓ phosphate, ½ hydrogen phosphate, dihydrogen phosphate, ½ C₁-C₄alkanephosphonate, C₁-C₄alkane-C₁-C₁₂alkylphosphonate, di-C₁-C₄alkylphosphinate, tetrafluoroborate, hexafluorophosphate, hexaflubroantimonate, acetate, trifluoroacetate, heptafluorobutyrate, ½ oxalate, methanesulfonate, trifluoromethanesulfonate, benzenesulfonate, tosylate, p-chlorobenzenesulfonate, p-nitrobenzenesulfonate, phenolate, benzoate and negatively charged metal complexes.

Free radicals of formula (I) are derived from formula (I) by abstraction of 1 or 2 hydrogen atoms. The number of bonds between free radicals of formula (I) is dependent upon the number of free radicals; generally n free radicals are bonded by n−1 bonds, but a higher number of bonds is on no account excluded (for example n bonds in the case of twice-bonded dimers or cyclic oligomers).

Halogen is chlorine, bromine, fluorine or Iodine, preferably fluorine, chlorine or bromine, especially fluorine on alkyl (for example trifluoromethyl, α,α,α-trifluoroethyl or perfluorinated alkyl groups, such as heptafluoropropyl) and chlorine or bromine on aryl, heteroaryl or on the aryl moiety of aralkyl or on the heteroaryl moiety of heteroaralkyl.

Alkyl, cycloalkyl, alkenyl or cycloalkenyl can be straight-chain or branched, or monocyclic or polycyclic. Alkyl is, for example, methyl, straight-chain C₂-C₁₂alkyl or preferably branched C₃-C₁₂alkyl. Alkenyl is, for example, straight-chain C₂-C₁₂alkenyl or preferably branched C₃-C₁₂alkenyl. The invention therefore relates especially also to compounds of formula (I) containing branched C₃-C₁₂alkyl or branched C₃-C₁₂alkenyl, and also to optical recording materials comprising such compounds. C₁-C₁₂Alkyl is therefore, for example, methyl, ethyl, n-propyl, isopropyl, n-butyl, sec-butyl, isobutyl, tert-butyl, n-pentyl, 2-pentyl, 3-pentyl, 2,2-dimethylpropyl, n-hexyl, n-octyl, 1,1,3,3-tetramethylbutyl, 2-ethylhexyl, nonyl, decyl or dodecyl. C₃-C₁₂Cycloalkyl is, for example, cyclopropyl, cyclobutyl, cyclopentyl, cyclohexyl, trimethylcyclohexyl, menthyl, thujyl, bornyl, 1-adamantyl or 2-adamantyl.

C₂-C₁₂Alkenyl or C₃-C₁₂cycloalkenyl is C₂-C₁₂alkyl or C₃-C₁₂cycloalkyl that is mono- or poly-unsaturated, wherein two or more double bonds may be isolated or conjugated, for example vinyl, allyl, 2-propen-2-yl, 2-buten-1-yl, 3-buten-1-yl, 1,3-butadien-2-yl, 2-cyclobuten-1-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbornadien-1-yl, 7,7-dimethyl-2,4-norcaradien-3-yl or the various isomers of hexenyl, octenyl, nonenyl, decenyl or dodecenyl.

C₇-C₁₈Aralkyl is, for example, benzyl, 2-benzyl-2-propyl, 13-phenyl-ethyl, 9-fluorenyl, α,α-dimethylbenzyl, ω-phenyl-butyl, ω-phenyl-octyl, ω-phenyl-dodecyl or 3-methyl-5-(1′,1′,3′,3′-tetramethyl-butyl)benzyl. When C₇-C₁₈aralkyl is substituted, both the alkyl moiety and the aryl moiety of the aralkyl group can be substituted, the latter alternative being preferred.

C₆-C₁₄Aryl is, for example, phenyl, naphthyl, biphenylyl, 2-fluorenyl, phenanthryl, anthryl or terphenylyl.

C₄-C₁₂Heteroaryl is an unsaturated or aromatic radical having 4n+2 conjugated π-electrons, for example 2-thienyl, 2-furyl, 2-pyridyl, 2-thiazolyl, 2-oxazolyl, 2-imidazolyl, isothiazolyl, triazolyl or any other ring system consisting of thiophene, furan, pyridine, thiazole, oxazole, imidazole, isothiazole, triazole, pyridine and benzene rings and unsubstituted or substituted by from 1 to 6 ethyl, methyl, ethylene and/or methylene substituents, for example benzotriazolyl, and in the case of N-heterocycles where applicable also those in the form of their N-oxides.

C₅-C₁₆Heteroaralkyl is, for example, C₁-C₈alkyl substituted by C₄-C₈heteroaryl.

Furthermore, aryl and aralkyl can also be aromatic groups linked to a metal, for example in the form of metallocenes of transition metals known per so, more especially

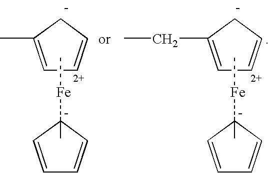

Preference is given to compounds of formula (I) wherein
A is 1,4-butadienylene;
M denotes 2 hydrogen atoms, Mg, Al, Si, Ti, V, Cr, Mn, Fe, Co, Ni, Cu, Zn, Zr, Mo, Pd, Sn, Hf, Pt or Pb, optionally coordinated or bonded to 1 or 2 additional ligands, depending upon valency;

Y is hydrogen, bromine, iodine, OR₄, NO₂, CN, unsubstituted C₁-C₁₂alkyl, C₃-C₁₂cylcoalkyl or C₂-C₁₂alkenyl, or C₆-C₁₀aryl or C₇-C₁₂aralkyl each unsubstituted or substituted by one or more, where applicable identical or different, radicals R₇;
R₁ is COOR₄, CONHR₄, CONR₄R₅, CO—R₄, SO₂R₄, or C₆-C₁₀aryl, C₄-C₈heteroaryl or C₇-C₁₂aralkyl each unsubstituted or substituted by R₇;
R₂ and R₃ are each independently of the other hydrogen or R₈;
R₄, R₅ and R₈ are each Independently of the others C₃-C₈alkyl, C₃-C₈cycloalkyl or C₃-C₈alkenyl each unsubstituted or substituted by R₆, or C₆-C₁₀aryl or C₁-C₁₂aralkyl each unsubstituted or substituted by R₇;
R₆ is halogen, hydroxy, O—R₉, O—CO—R₉, CO—R⁹, cyano or SO₂R₉;
R₇ is halogen, nitro, cyano, O—CO—R₁₅, NR₁₅R₁₆, CONHR₁₅, CONR₁₅R₁₆, SO₂R₁₅, SO₂NH₂, SO₂NHR₁₅, SO₂NR₁₅R₁₆, COOH, COOR₁₅, NHCOR₁₅, NR₁₅COR₁₇, or unsubstituted or substituted C₁-C₁₂alkyl, C₃-C₁₂cycloalkyl, C₁-C₁₂alkoxy or C₃-C₁₂cycloalkoxy;
R₉ and R₁₀ are each independently of the other C₁-C₈alkyl, C₃-C₆cycloalkyl, C₂-C₈alkenyl, C₃-C₆cycloalkenyl or phenyl;
R₉ and R₁₀ together with the common N are pyrrolidine, piperidine, piperazine or morpholine each unsubstituted or mono- to tetra-substituted by C₁-C₄alkyl;
R₁₅, R₁₆ and R₁₇ are each independently of the others C₁-C₈alkyl, C₅-C₆cycloalkyl, C₂-C₈alkenyl or C₅-C₆cycloalkenyl each unsubstituted or substituted by one or more, where applicable identical or different, halogen, hydroxy or C₁-C₄alkoxy radicals, or phenyl or benzyl each unsubstituted or substituted by one or more, where applicable identical or different, halogen, nitro, C₁-C₈alkyl or C₁-C₄alkoxy radicals;
R₁₅ and R₁₆ together with the common N are pyrrolidine, piperidine, piperazine or morpholine each unsubstituted or mono- to tetra-substituted by C₁-C₄alkyl; and/or
x is a number from 1 to 4, and y is a number from 0 to 4,
wherein from 2 to 5 identical or different radicals of formula (I) can be bonded to one another by one or more additional bonds between two or more identical or different R₁, R₂, R₃ or Y, so that dimers, trimers or oligomers having 4 or 5 phthalocyanine units are formed.

Special preference is given to compounds of formula (I) wherein
M is Co(II), Ni(II), Cu(II), Zn(II), Sn(I) or Pb(II), especially Cu(II);
Y is hydrogen, bromine or OR₄, very especially hydrogen;
R₁ is COOR₄, CONHR₄, CONR₄R₅, CO—R₄, SO₂R₄, or unsubstituted or substituted phenyl or C₇-C₁₂aralkyl, very especially CO—R₄, SO₂R₄ or unsubstituted or substituted phenyl or C₇-C₁₂aralkyl;
R₂ and R₃ are each independently of the other hydrogen or C₁-C₁₂alkyl;
R₄, R₅ and R₈ are each independently of the others C₃-C₈alkyl unsubstituted or substituted by R₆, or phenyl unsubstituted or substituted by R₇;
R₆ is halogen, hydroxy, O—R₉, O—CO—R₉, CO—R⁹, cyano or SO₂R₉;
R₇ is halogen, nitro, cyano, O—CO—R₁₅, NR₁₅R₁₆, or C₁-C₁₂alkyl, C₃-C₁₂cycloalkyl, C₁-C₁₂alkoxy or C₃-C₁₂cycloalkoxy each unsubstituted or substituted by R₆;
R₉ and R₁₀ are each independently of the other C₁-C₄alkyl or phenyl;
R₉ and R₁₀ together with the common N are piperidine or morpholine each unsubstituted or mono- to tetra-substituted by C₁-C₂alkyl;
R₁₅, R₁₆ and R₁₇ are each independently of the others C₁-C₄alkyl unsubstituted or substituted by one or more, where applicable identical or different, halogen, hydroxy or C₁-C₄alkoxy radicals; and/or
R₁₅ and R₁₆ together with the common N are piperidine or morpholine each unsubstituted or mono- to tetra-substituted by C₁-C₄alkyl.

Those preferred meanings apply both individually and in any combination. The compounds of formula (I) generally exhibit more advantageous properties, the more preferred individual features they have.

The recording layer advantageously comprises a compound of formula (I) or a mixture of such compounds as main constituent or at least as an important component, for example from 1 to 100% by weight, preferably from 20 to 100% by weight, especially from 50 to 100% by weight. Further customary constituents are possible, for example other chromophores (for example those having an absorption maximum at from 300 to 1000 nm), stabilisers, ¹O₂-, triplet- or luminescence-quenchers, melting-point reducers, decomposition accelerators or any other additives that have already been described in optical recording media. Preferably, stabilisers or fluorescence-quenchers are added if desired.

Chromophores which may optionally be used in the recording layer in addition to the compounds of formula (I) are, for example, cyanines and cyanine metal complexes (U.S. Pat. No. 5,958,650), aza- and phospha-cyanines (WO 02/082438), stryl compounds (U.S. Pat. No. 6,103,331), oxonol dyes (EP 0 833 314), azo dyes and azo metal complexes (JP 11/028 865A), phthalocyanines (EP 0 232 427, EP 0 337 209, EP 0 373 643, EP 0 463 550, EP 0 492 508, EP 0 509 423, EP 0 511 590, EP 0 513 370, EP 0 514 799, EP 0 518 213, EP 0 519 419, EP 0 519 423, EP 0 575 816, EP 0 600 427, EP 0 676 751, EP 0 712 904, WO 98/14 520, WO 00/09 522, WO 02/25 648, WO 02/083 796, EP 1 253 586, EP 1 265 233, EP 1 271 500), porphyrins, porphyrazines (EP 0 822 546, U.S. Pat. No. 5,998,093, JP 2001/277 723 A, WO 03/042 990), carbopyronins (WO 03/007 296), dipyrro-methene dyes and metal chelate compounds thereof (EP 0 822 544, EP 0 903 733), xanthene dyes and metal complex salts thereof (U.S. Pat. No. 5,851,621, WO 03/098 617, WO 03/098 618, pyridone metal complexes (WO 03/063 151) or quadratic acid compounds (EP 0 568 877), or oxazines, dioxazines, diazastyryls, formazans, anthraquinones or phenothiazines; this list is on no account exhaustive and the person skilled in the art will interpret the list as including further known dyes, for example those of PCT/EP04/050185 or PCT/EP04/050206.

Mixtures have, as is known, a number of advantages, for example better solubility and a lower tendency towards crystallisation, so that it is easier to produce stably amorphous layers by spin-coating. By optimisation of the mixing ratios in known manner there are obtained solid recording layers having advantageous thermal and optical properties, especially having steep absorption bands. In addition, it is often thus possible to counteract the flattening of the spectral absorption edge in the solid state. Optimum mixing ratios are therefore generally determined by series of tests, in which different groove geometries are also included.

It will be understood that, where applicable, preference is given to those additional dyes which are themselves known for use in optical recording materials at from 300 to 500 nm. Special preference is given to mixtures of the compounds of formula (I) and their isomers. When the recording layer comprises other chromophores that are not suitable per se for use at from 300 to 500 nm, the amount of such chromophores should preferably be small, so that the absorption thereof at the wavelength of the inflection point (point of maximum gradient) of the long-wavelength flank of the absorption band of the entire solid layer, which is a decisive factor for the recording, is a fraction of the absorption of the compounds of formula (I) in the entire solid layer at the same wavelength, advantageously at most ⅓, preferably at most ⅕, especially at most 1/10. The absorption maximum of dye mixtures in the spectral range from 300 to 500 nm is preferably at a wavelength lower than 450 nm, preferably lower than 400 nm, especially at 340-380 nm.

Stabilisers and ¹O₂-, triplet- or luminescence-quenchers are, for example, metal complexes of N- or S-containing enolates, phenolates, bisphenolates, thiolates or bisthiolates or of azo, azomethine or formazan dyes, such as bis(4-dimethylamino-dithiobenzil)nickel [CAS No 38465-55-3], ®Irgalan Bordeaux EL, ®Cibafast N or similar compounds, hindered phenols and derivatives thereof, such as ®Cibafast AO, o-hydroxyphenyl-triazoles or -triazines or other UV absorbers, such as ®Cibafast W or ®Cibafast P or hindered amines (TEMPO or HALS, also as nitroxides or NOR-HALS, also diimmonium, Paraqua™ or Orthoqua™ salts, such as ®Kayasorb IRG 022, ®Kayasorb IRG 040, or optionally also radical salts, such as N,N,N′,N′-tetrakis(4-dibutylaminophenyl)-p-phenyleneamine-ammonium salts. The latter are available from Organica (Wolfen/DE); ®Kayasorb brands are available from Nippon Kayaku Co. Ltd., and ®Irgalan and ®Cibafast brands are available from Ciba Spezialitätenchemie AG.

Many such structures are known, some of them also in connection with optical recording media, for example from U.S. Pat. No. 5,219,707, JP 06/199045 A, JP 07/76169 A, JP 07/262604 A or JP 2000/272241 A. They may be, for example, salts of metal complex anions, as disclosed in the above-mentioned publications, or metal complexes, illustrated, for example, by a compound of formula

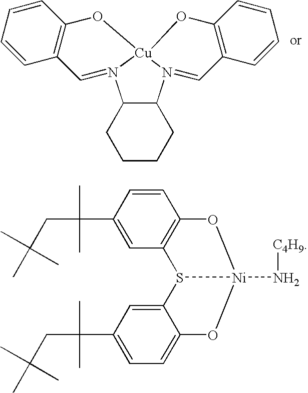

The person skilled in the art will know from other optical information media, or will easily identify, which additives in which concentration are particularly well suited to which purpose. Suitable concentrations of additives are, for example, from 0.001 to 1000% by weight, preferably from 1 to 50% by weight, based on the recording medium of formula (I).

Although their refractive index is not particularly high, the optical recording materials according to the invention exhibit, overall, excellent spectral properties of the solid amorphous recording layer. By virtue of an aggregation tendency in the solid that is surprisingly low for such compounds, the absorption band is narrow and intense, the absorption band being especially steep on the long-wavelength side. Crystallites are unexpectedly and very advantageously not formed or are formed only to a negligible extent. The reflectivity of the layers in the range of the writing and reading wavelength is high in the unwritten state.

In comparison with known dyes having comparable spectral absorption, especially on the bathochromic flank of the recording band (inter alia similar k), the compounds according to the invention very surprisingly exhibit considerably higher sensitivity towards laser radiation in the recording mode. At the same time, however, the compounds according to the invention are, astonishingly, extraordinarily stable with respect to laser radiation of the same wavelength in the lower energy readout mode.

By virtue of those excellent layer properties it is possible to obtain a rapid optical recording having high sensitivity, high reproducibility and geometrically very precise mark boundaries, the refractive index and the reflectivity changing substantially, which gives a high degree of contrast. The differences in the mark lengths and the interval distances (“jitter”) are surprisingly small both at normal recording speed (about from 4.8 to 5.5 m·s⁻¹) and at a higher recording speed (for example from 10 m·s⁻¹ to 25 m·s⁻¹ or even higher), which enables a high storage density to be obtained using a narrow recording channel with a relatively small track spacing (“pitch”). In addition, the recorded data are played back with an astonishingly low error rate, so that relatively short marks are possible, including, for example, those of length 0.15±0.01 μm (2T) in conformity with the Blu-Ray™ Standard, and error correction requires only a small amount of storage space.

By virtue of the excellent solubility, including in apolar solvents, solutions can be used even in high concentrations without troublesome precipitation, for example during storage, so that problems during spin-coating are largely eliminated. This applies especially to compounds containing branched C₃-C₈alkyl.

Recording and playback can take place at the same wavelength with a laser source of advantageously from 300 to 500 nm, preferably from 370 to 450 nm. Especially preferred is the UV range from 370 to 390 nm, especially approximately 380 nm, or especially at the edge of the visible range of from 390 to 430 nm, more especially approximately 405±5 nm. In the field of compact, blue or violet laser diodes (such as Nichia GaN 405 nm) with an optical system of high numerical aperture (for example 0.85) the marks can be so small and the tracks so narrow that up to about 20 to 25 Gb per recording layer is achievable on a 120 mm disc. At 380 nm it is possible to use indium-doped UV-VCSELs Vertical-Cavity Surface-Emitting Laser), which laser source already exists as a prototype [Jung Han et al., see MRS Internet J. Nitride Semicond. Res. 5S1, W6.2 (2000)].

The invention therefore relates also to a method of recording or playing back data, wherein the data on an optical recording medium according to the invention are recorded or played back at a wavelength of from 300 to 500 nm. The recording preferably takes place at a linear speed ν of at least 4.8 m·s⁻¹ and an output P of at most [ν/0.1 m·s⁻¹]^{1/2} mW, there especially being created marks of different lengths, the shortest of which are almost circular and the longest of which are of a length corresponding to approximately four times the width. The linear speed is especially at least 9.6 m·s⁻¹, 19.2 m·s⁻¹ or 38.4 m·s⁻¹-(corresponding to P≦9.8 mW, P≦13.9 mW and P≦19.6 mW, respectively).

The recording medium can be based on the structure of known recording media and in that case is, for example, analogous to those mentioned above, such as DVD+R or DVD-R. It may therefore be composed, for example, of a transparent substrate, a recording layer comprising at least one of the compounds of formula (I), a reflector layer and a covering layer, the writing and readout being effected through the substrate. Such a system suitable for recording and playback at a wavelength of from 300 to 500 nm is, for example, HD-DVD™ (formerly known as advanced optical disk AOD).

Suitable substrates are, for example, glass, minerals, ceramics and thermosetting and thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. Special preference is given to polycarbonate substrates which can be produced, for example, by injection-moulding. The substrate can be in pure form or may comprise customary additives, for example UV absorbers or dyes, as proposed e.g. in JP 04/167239 A as light stabilisation for the recording layer. In the latter case it may be advantageous for the dye added to the support substrate to have no or at most only low absorption in the region of the writing wavelength (emission wavelength of the laser), preferably up to a maximum of about 20% of the laser light focussed onto the recording layer.

The substrate is advantageously transparent over at least a portion of the range from 300 to 500 nm, so that it is permeable to, for example, at least 80% of the incident light of the writing or readout wavelength. Its thickness is advantageously from 10 μm to 2 mm, preferably from 100 to 1200 μm, especially from 600 to 1100 μm. On the coating side of the substrate, there is generally an embossed, preferably spiral guide groove (track). Grooves of different cross-sectional shape are known, for example rectangular, trapezoidal or V-shaped. Analogously to the known CD-R and DVD±R media, the guide groove may additionally undergo a small periodic or quasi-periodic lateral deflection (wobble), so that synchronisation of the speed of rotation and the absolute positioning of the readout head (pick-up) is made possible. Instead of, or in addition to, the deflection, the same function can be performed by markings between adjacent grooves (pre-pits).

Two fundamentally different systems are known for optical recording at 350 to 600 nm, though there are no final specifications for WORM media yet. These are mainly HD-DVD™ (formerly Advanced Optical Disc AOD) and Blu-ray™ (formerly Blu-ray Disk=BD).

In case of HD-DVD™, the track has a groove depth of from 10 to 200 nm, preferably from 50 to 150 nm, a groove width of from 100 to 400 nm, preferably from 120 to 250 nm, and an axial spacing between two grooves of from 200 to 600 nm, preferably from 250 to 450 nm (for example with a groove depth of 100±20 nm, a groove width of 200±50 nm and an axial spacing between two turns of 370±60 nm).

The recording medium is applied, for example, by application of a solution by spin-coating, the objective being to produce a layer that is as amorphous as possible, the thickness of which layer is advantageously from 0 to 70 nm, preferably from 1 to 20 nm, especially from 2 to 10 nm, on the surface (“land”) and, depending upon the geometry of the groove, advantageously from 20 to 150 nm, preferably from 30 to 120 nm, especially from 30 to 80 nm, in the groove. In a novel embodiment, achievable only by means of the compounds of formula (I), the thickness of the recording layer on the surface (“land”) may advantageously be from 20 to 70 nm and in the groove from 30 to 80 nm, the difference between the layer thicknesses in the groove and on the surface being less than 20 nm, preferably less than 10 nm. As a result it is possible, compatibly with HD-DVD-RW, to write and read both in the grooves and on the surface alongside. The track pitch is in that case only about half as great, and the total storage capacity is greater.

In both embodiments, writing and readout take place from the substrate side. The laser beam is directed onto the recording layer through the substrate and has a wavelength of preferably from 300 to 500 nm, especially from 370 to 450 nm. A reflector layer may be present on the side of the recording layer opposite from the substrate.

Reflecting materials suitable for the reflector layer include especially metals, which provide good reflection of the laser radiation used for recording and playback, for sample the metals of Main Groups III, IV and V and of the Sub-Groups of the Periodic Table of the Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt and the lanthanide metals Ce, Pr, Nd, Pm, Sm, Eu, Gd, Tb, Dy, Ho, Er, Tm, Yb and Lu and alloys thereof are especially suitable. On account of its high reflectivity and ease of production special preference is given to a reflective layer of aluminium, silver, gold or an alloy thereof (for example a white gold alloy), especially aluminium on economic and ecological grounds. The reflector layer is advantageously from 5 to 200 nm thick, preferably from 10 to 100 nm thick, especially from 30 to 80 nm thick, but reflector layers of greater thickness are also possible.

Materials suitable for the covering layer include chiefly plastics, which are applied in a thin layer to the reflector layer either directly or with the aid of adhesion promoters. It is advantageous to select mechanically and thermally stable plastics having good surface properties, which can be modified further, for example written on. The plastics may be thermosetting plastics and thermoplastic plastics. Directly applied covering layers are preferably radiation-cured (e.g. using UV radiation) coatings, which are particularly simple and economical to produce. A wide variety of radiation-curable materials are known. Examples of radiation-curable monomers and oligomers are acrylates and methacrylates of diols, triols and tetrols, polyimides of aromatic tetracarboxylic acids and aromatic diamines having C₁-C₄alkyl groups in at least two ortho-positions of the amino groups, and oligomers with dialkylmaleinimidyl groups, e.g. dimethylmaleinimidyl groups. For covering layers that are applied using adhesion promoters it is preferable to use the same materials as those used for the substrate layer, especially polycarbonates. The adhesion promoters used are preferably likewise radiation-curable monomers and oligomers. Instead of the covering layer applied using an adhesion promoter there may also be used a second substrate comprising a recording and reflector layer, so that the recording medium is playable on both sides. Preference is given to a symmetrical structure, the two parts being joined together at the reflector side by an adhesion promoter directly or by way of an intermediate layer.

In such a structure, the optical properties of the covering layer, or the covering materials, are essentially unimportant per se provided that, where applicable, curing thereof e.g. by UV radiation is achieved. The function of the covering layer is to ensure the mechanical strength of the recording medium as a whole and, if necessary, the mechanical strength of thin reflector layers. If the recording medium is sufficiently robust, for example when a thick reflector layer is present, it is even possible to dispense with the covering layer altogether. The thickness of the covering layer depends upon the thickness of the recording medium as a whole, which should preferably be a maximum of about 2 mm thick. The covering layer is preferably from 10 μm to 1 mm thick.

The recording media according to the invention may also have additional layers, for example interference layers or barrier layers. It is also possible to construct recording media having a plurality of (for example from two to ten) recording layers. The structure and the use of such materials are known to the person skilled in the art. Where present, interference layers are preferably arranged between the recording layer and the reflecting layer and/or between the recording layer and the substrate and consist of a dielectric material, for example, as described in EP 0 353 393, of TiO₂, Si₃N₄, ZnS or silicone resins.

The recording media according to the invention can be produced by processes known per se, it being possible for various methods of coating to be employed depending upon the materials used and their function.

Suitable coating methods are, for example, immersion, pouring, brush-coating, blade-application and spin-coating, as well as vapour-deposition methods carried out under a high vacuum. When, for example, pouring methods are used, solutions in organic solvents are generally employed. When solvents are employed, care should be taken that the supports used are insensitive to those solvents. Suitable coating methods and solvents are described, for example, in EP 0 401 791.

The recording layer is applied preferably by the application of a dye solution by spin-coating, solvents that have proved satisfactory being especially alcohols, for example 2-methoxyethanol, 2-methoxypropanol, isopropanol or n-butanol, hydroxyketones, for example diacetone alcohol or 3-hydroxy-3-methyl-2-butanone, hydroxy esters, for example lactic acid methyl ester or isobutyric acid methyl ester, or preferably fluorinated alcohols, for example 2,2,2-trifluoroethanol or 2,2,3,3-tetrafluoro-1-propanol, and mixtures thereof. Further suitable solvents are disclosed, for example, in EP0483387. Though they are not inert against plastics, many other solvents usual in organic chemistry can also be used when coating onto a metallic reflector or an inorganic intermediate layer, for example aromatics, chlorinated hydrocarbons and esters, such as toluene, dichloromethane or methyl acetate.

The application of the metallic reflector layer is preferably effected by sputtering or by vapour-deposition in vacuo. Such techniques are known and are described in specialist literature (e.g. J. L. Vossen and W. Kern, “Thin Film Processes”, Academic Press, 1978). The operation can advantageously be carried out continuously and achieves good reflectivity and a high degree of adhesiveness of the metallic reflector layer.

Recording is carried out in accordance with known methods by writing pits (marks) of fixed or, usually, variable length by means of a modulated, focussed laser beam guided at a constant or variable speed over the surface of the recording layer. Readout of information is carried out according to methods known per se by registering the change in reflection using laser radiation, for example as described in “CD-Player und R-DAT Recorder” (Claus Biaesch-Wiepke, Vogel Buchverlag, Würzburg 1992). The person skilled in the art will be familiar with the requirements.

The information-containing medium according to the invention is especially an optical information material of the WORM type. It can be used, for example, analogously to CD-R (compact disc-recordable), DVD+R or DVD-R (digital video disc-recordable) in computers, and also as storage material for identification and security cards or for the production of diffractive optical elements, for example holograms. Recording media of the HD-DVD type allow the use of a laser having a numerical aperture of a maximum of about 0.7 (usually about 0.65), in which case at a recording speed of 6.61 m·s⁻¹ (or a multiple thereof), discs of 120 mm diameter will have a storage capacity of 15 GB per recording layer.

Alternatively, however, there are also recording media which differ substantially from CD-R and DVD±R and in which recording and playback take place not through the substrate but through the covering layer. Accordingly the respective roles of the covering layer and the substrate, especially the geometry and the optical properties, are reversed in comparison with the structure described before. Analogous concepts have been described a number of times for digital video recordings in conjunction with a blue GaN laser diode, for example in Proceedings SPIE-Int. Soc. Opt. Eng. 1999, 3864. Also at an advanced stage of development is Blu-ray™ (formerly Blu-ray disc “BD”) with a recording speed of 5.0±0.3 m·s⁻¹ (later presumably a multiple thereof) and a storage capacity of 25±2 GB (see system description “Blu-ray Disc Rewritable Format version 1.0”/June 2002 as well as Blu-ray.com). For such recording media, which are especially suitable for a high storage density and have correspondingly small marks (“pits”), precise focussing is important, so that the manufacturing process, while essentially analogous, is considerably more awkward.

The compounds of formula (I) according to the invention, however, also meet the increased demands of an inverse layer structure such as that of Blu-ray™ surprisingly well. Preference is therefore given to an inverse layer structure having the layer sequence substrate, reflector layer, recording layer and covering layer. The recording layer is therefore located between the reflector layer and the covering layer. A thin covering layer approximately from 50 to 400 μm in thickness is especially advantageous (typically 100 μm at a numerical aperture of 0.85).

Recording and reflector layers in an inverse layer structure have in principle the same functions as indicated above. The substrate usually has dimensions within the ranges indicated above. The preferably spiral guide groove (track) on the coating side advantageously has a groove depth of from 10 to 100 nm, preferably from 20 to 80 nm. The cross-sectional shape, periodic or quasi-periodic lateral deflection (wobble) as well as any additional markings between adjacent grooves (pre-pits) will be based on the HD-DVD type described above.

The reflector layer and the recording layer are applied to the substrate in that order. Both the grooves and the rail-like raised areas between them can be utilised as the track, reference usually being made to ‘in-groove’ media in the first case and to “on-groove” media in the second case. Using the compounds of formula (I) it is advantageously possible to achieve both forms, possibly also simultaneously.

The recording medium is applied, for example, as indicated above, it being especially advantageous that it is possible also to select solvents that would attack the substrate material, for example chlorinated or aromatic hydrocarbons. The thickness of the layer, which is as amorphous as possible, can be uniform or it can be different in the grooves or on the raised portions. In the grooves the thickness of the recording layer is advantageously from 20 to 200 nm, preferably from 30 to 150 nm, especially from 30 to 100 nm. When the track on the raised portions is to be used for recording, its layer thickness is advantageously from 10 to 120 nm, preferably from 20 to 100 nm, especially from 20 to 60 nm, whereas when only the groove is used as the track, a layer thickness of from 0 to 100 nm, preferably from 0 to 60 nm, especially from 0 to 20 nm, is sufficient. In both cases the track width (raised portions and/or indentations) is advantageously from 100 to 300 nm, preferably from 120 to 250 nm, especially from 150 to 200 nm, and the axial spacing between two tracks is from 200 to 600 nm, preferably from 250 to 400 nm, especially from 300 to 340 nm. Good results are obtained, for example, with a raised track (“on-groove”) 30±10 nm deep and 180±10 nm wide with an axial spacing of 320±10 nm. In that case, resolution is increased as the laser beam passes through the covering layer with a high numeric aperture.

The inverse layer structure requires particularly high standards, which the compounds used according to the invention fulfil astonishingly well, for example when the recording layer is applied to the metallic reflector layer and especially when a covering layer is applied to the recording layer, the covering layer being required to provide the recording layer with adequate protection against rubbing, photo-oxidation, fingermarks, moisture and other environmental effects and advantageously having a thickness in the range of from 0.01 to 0.5 mm, preferably in the range of from 0.05 to 0.2 mm, especially in the range of from 0.08 to 0.13 mm.

The covering layer preferably consists of a material that exhibits a transmission of 80% or above at the writing or readout wavelength of the laser. Suitable materials for the covering layer include, for example, those materials mentioned above, but especially polycarbonate (such as Pure Ace® or Panlite®, Teijin Ltd), cellulose triacetate (such as Fujitac®, Fuji Photo Film) or polyethylene terephthalate (such as Lumirror®, Toray Industry), special preference being given to polycarbonate. Especially in the case of directly applied covering layers, radiation-cured coatings, such as those already described above, are advantageous, for example SD 347™ (Dainippon Ink).

The covering layer can be applied directly to the solid recording layer by means of a suitable adhesion promoter. In another embodiment, there is applied to the solid recording layer an additional, thin separating layer of a metallic, crosslinked organometallic or preferably dielectric inorganic material, for example in a thickness of from 0.001 to 10 μm, preferably from 0.005 to 1 μm, especially from 0.01 to 0.1 μm, for example from 0.05 to 0.08 μm in the case of dielectric separating layers and from 0.01 to 0.03 μm in the case of metallic separating layers. Separating layers and corresponding methods are disclosed in WO 02/082438, to which reference is expressly made here. If desired, such coatings can be applied, for example, in the same thickness also between the support material and the metallic reflector layer or between the metallic reflector layer and the optical recording layer. This may be advantageous in certain cases, for example when a silver reflector is used in combination with sulfur-containing additives in the recording layer.

Some of the compounds used according to the invention are known, especially Com J. Org. Chem. 67/16, 5753-5772 [2002].

It is also possible, however, to prepare analogously to the known compounds novel compounds that can be used in accordance with the invention in optical recording media.

The following Examples illustrate the invention but do not limit the scope thereof (unless otherwise indicated, “%” always refers to % by weight):

### EXAMPLE 1

140 g of copper phthalocyanine and 580 ml of chlorosulfonic acid are introduced into a 1.5 litre glass vessel equipped with an anchor stirrer, thermometer, reflux condenser, dropping funnel, nitrogen transfer line and gas washer. An exothermic reaction begins and the internal temperature rises to 65° C. The brown solution is heated to an internal temperature of 140° C. and is stirred at that temperature for 3 hours. The reaction mixture is then cooled to an internal temperature of 85° C. and 175 ml of thionyl chloride are added dropwise within a period of 15 min. The temperature is then maintained at 80 to 85° C. for 3 hours and then cooled to 23° C. With vigorous stirring, the reaction mixture is slowly added dropwise to a mixture of 4 litres of water and 4 kg of ice in a 10 litre reaction vessel equipped with an anchor stirrer, thermometer, reflux condenser and gas washer. Vigorous evolution of gas begins and the temperature of the blue suspension rises to 20° C. When the addition is complete, the suspension is filtered, washed 3× using 2 litres of water each time and suction-dried thoroughly for 15 min. Chloro-sulfamoyl-substituted copper phthalocyanine of the following structure is obtained, which is further processed immediately:

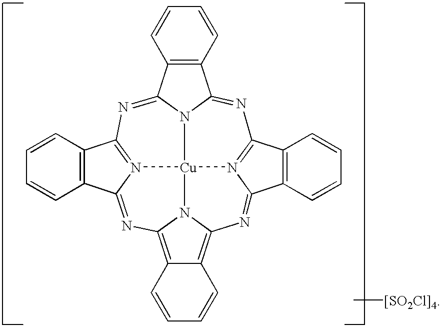

### EXAMPLE 2

In a 6 litre glass vessel equipped with an anchor stirrer, thermometer, reflux condenser, dropping funnel and nitrogen transfer line, the moist sulfo-chlorinated copper phthalocyanine according to Example 1 is introduced into 3 litres of tetrahydrofuran (THF). 385 g of tert-butyl carbazate dissolved in 1 litre of THF are introduced and the resulting solution is stirred for 1 hour at 23° C. The solvent is distilled off at 40° C. and the blue, pasty residue is dissolved in 2 litres of dichloromethane and, with stirring, added dropwise to 14 litres of hexane. The suspension is filtered, the residue is washed 2× using 500 ml of hexane each time and dried for 18 hours at 60° C./2.5·10³ Pa. The crude product is dissolved in 5 litres of ethyl acetate, and insoluble portions are separated off by filtration. The filtrate is concentrated to a volume of 1.2 litres by evaporation and purified by means of chromatography on 1.8 kg of silica gel with ethyl acetate as eluant. The pure fractions are combined and concentrated by evaporation. The residue is dissolved in 500 ml of dichloromethane and, with stirring, added dropwise to 6.5 litres of hexane. The precipitate is filtered off, the residue is washed 2× using 500 ml of hexane each time and dried for 18 hours at 60° C./2.5*10³ Pa. 153.7 g of 4-tert-butyl-carbazatosulfamoyl-substituted copper phthalocyanine of the following structure are obtained:

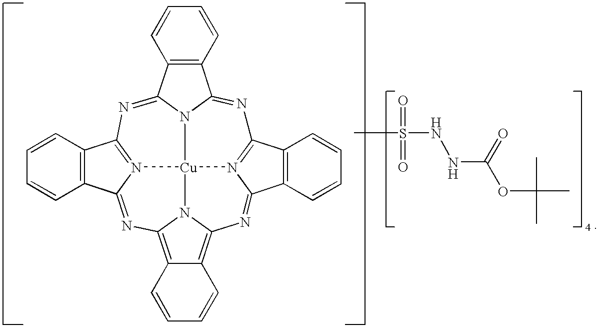

UV/VIS (NMP): λₘₐₓ=673 nm, ∈=153 800 l·mol⁻¹·cm⁻¹;
TGA: maximal rate of decomposition=173° C.

### EXAMPLE 3

14.55 g of chlorosulfamoyl-substituted copper phthalocyanine according to Example 1 are suspended in 750 ml of dichloromethane. 24.57 g of 4-tert-butyl benzhydrazide are introduced, with stirring. After stirring for 15 hours at 23° C., filtration is carried out and the filtrate is concentrated by evaporation in vacuo. The residue is purified by means of column chromatography on 1.2 kg of silica gel with ethyl acetate as eluant. 12.37 g of 4-tert-butyl-benzhydrazido-sulfamoyl-substituted copper phthalocyanine of the following structure are obtained in the form of a blue powder:

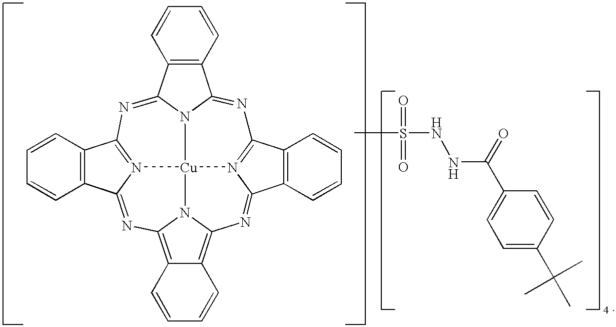

UV/VIS (CH₂Cl₂): λₘₐₓ=673 nm, ∈=139 800 l·mol⁻¹·cm⁻¹;
TGA: maximal rate of decomposition=253° C.

### EXAMPLES 4-11

Analogously to Example 2, the compounds listed in the following Table are prepared from various hydrazines which are either commercially available or produced analogously to known procedures in the literature. The DSC values relate to differential calorimetry, measured from 30 to 500° C. at a heating rate of 10° C./min., the beginning of decomposition and the maximum decomposition rate of the first decomposition stage (1st peak) being indicated:

| | | Yield | DSC [° C.] | | |
|---|---|---|---|---|---|
| Example | Hydrazine starting material | [% of th.] | Start | 1st peak | λₘₐₓ [nm] |
| 4 | 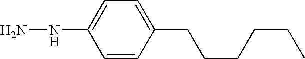 | 65 | 230 | 275 | 676 (NMP) |
| 5 | 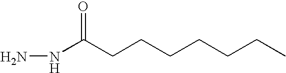 | 11 | 170 | 221 | 673 (CH₂Cl₂) |
| 6 | 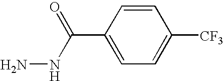 | 4 | 225 | 265 | 675 (NMP) |
| 7 | 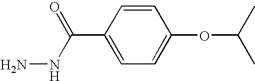 | 39 | 220 | 262 | 674 (CH₂Cl₂) |
| 8 | 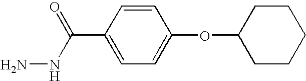 | 50 | 220 | 264 | 674 (CH₂Cl₂) |
| 9 | 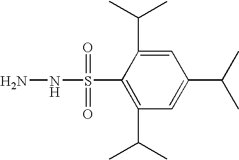 | 51 | — | — | 671 (CH₂Cl₂) |
| 10 | 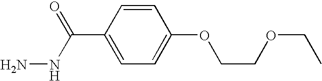 | 95 | — | — | 676 (NMP) |
| 11 | 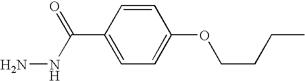 | 30 | 200 | 248 | 673 (CH₂Cl₂) |

By way of comparison, the following DSC values are obtained for Orasol® Blue GN: Start 285° C., first peak 312° C.

### EXAMPLES 12-15

The compounds of the following structure are prepared analogously to Examples 1 and 3:

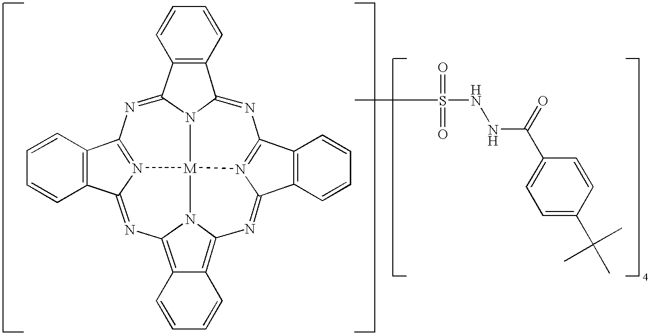

| Example | M | Yield [% of th.] | λₘₐₓ [nm] | Solvent |
|---|---|---|---|---|
| 12 | Co | 16 | 667 | CH₂Cl₂ |
| 13 | Ni | 30 | 662 | CH₂Cl₂ |
| 14 | Fe | 16 | 571 | NMP |
| 15 | V (═O) | 4 | 687 | NMP |

### EXAMPLE 16

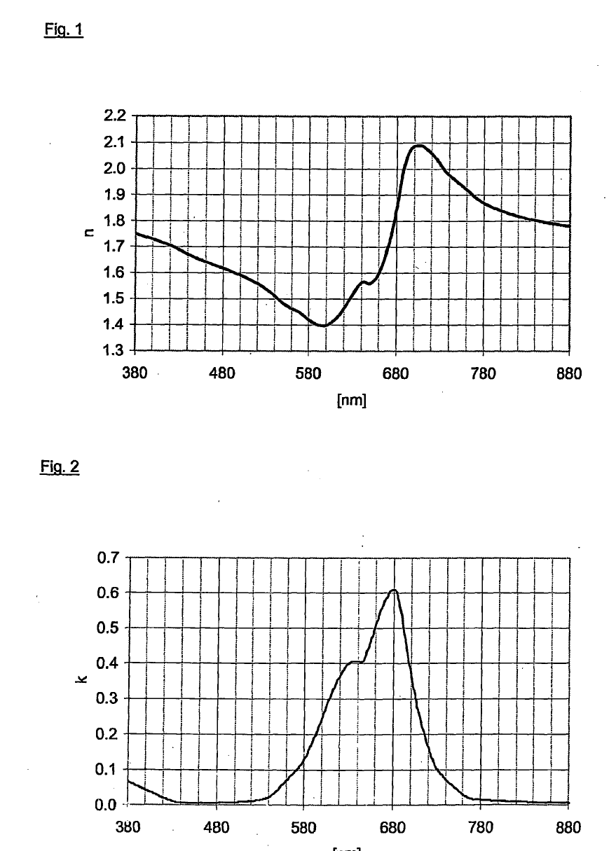

3 g of the compound according to Example 3 are dissolved in 97 g of diacetone alcohol and filtered through a 0.2 μm Teflon filter. The dye solution is then applied at 200 rev/min to a 0.6 mm thick, planar polycarbonate plate (diameter 120 mm) and spin-coated at 2500 rev/min, a uniform solid layer being formed. After drying, the solid layer has an absorption of 0.19 at 350 nm. Using an optical measuring system (ETA-RT™, STEAG ETA-Optik), the layer thickness and the refractive index are determined. At 405 nm the dye layer has a layer thickness of 44 nm, a refractive index n of 1.75 and an extinction coefficient k of 0.067. FIG. 1 shows the refractive index n, FIG. 2 shows the extinction coefficient k, each as a function of wavelength.

### EXAMPLE 17

In a vacuum-coating apparatus (Twister™, Balzers Unaxis), a 40 nm thick silver reflector layer is applied to a 0.6 mm thick, grooved polycarbonate disc (diameter 120 mm, groove pitch 1.0 μm, groove depth 51 nm, groove width 330 nm). 3% by weight of the compound according to Example 3 are dissolved in diacetone alcohol and filtered through a 0.2 μm Teflon filter. The dye solution is then applied over the reflector layer by the spin-coating method at from 250 to 2000 rev/min, the excess solution being spun off and a uniform solid layer being obtained. After drying (1 hour, 25° C.), the solid layer has an absorption of 0.28 at 680 nm. A UV-crosslinkable photopolymer (SD-347™, DIC) is then applied by spin-coating in a thickness of about 10 μm and is crosslinked with UV light. At 405 nm the recording layer has a reflectivity of 32%. Using a GaN laser diode (Nichia) of wavelength 404 nm, marks are written into the active layer at an output of 6 mW and a linear speed of 5 m/s. This operation results in a change in reflection at the written sites from 32% to 14%.

### EXAMPLES 18-29

The compounds according to Examples 4 to 15 are used analogously to Example 17. The respective systems can be optimised further by adapting the layer thickness and the disc geometry.

### EXAMPLE 30

In a vacuum-coating apparatus (Twister™, Balzers Unaxis), a 30 nm thick silver reflector layer is applied onto a 1.1 mm thick grooved polycarbonate disc (diameter 120 mm, groove pitch 400 nm, groove depth 80 nm, groove width 170 nm). 40 g of the compound according to Example 3 are dissolved in 1 liter 1-methoxy-2-propanol and filtered through a 0.2 μm Teflon™ filter. The dye solution is applied onto the reflector layer by the spin-coating method in order to form a uniform solid layer which, after drying in an oven for 15 min at 70° C., has an absorption of 0.6 at wavelength 678 nm. A 40 nm thick dielectric layer (SiON) is successively applied by RF-sputtering in a vacuum-coating apparatus (Cube™, Balzers Unaxis). A polycarbonate film covered on one side with a pressure-sensitive adhesive (total thickness 100 μm, Lintec Corp., Japan) is finally bonded onto the dielectric layer. Using a commercial disc testing equipment (ODU-10000 for Blu-ray® Disc, Pulstec, Japan) based on a 407 nm laser diode and an objective lens numerical aperture of 0.85, marks are recorded on the disc with a linear speed of 5.28 m/s and a laser power of 7 mW. The recorded area is then read back with 6.35 mW laser power and the following signal parameters are measured: App/l8H=0.50; l3 pp/l8 pp=0.26; R₈H*l8 pp/l8H=0.13.

### EXAMPLE 31

### Comparative

A disc is prepared under the same conditions as described in example 30, except that 20 g Orasol® Blue GN (Ciba Specialty Chemicals Ltd.) are dissolved in 1 liter tetrafluoro-1-propanol and filtered through a 0.2 μm Teflon™ filter. After the spin-coating and drying process, the disc has an absorption of 0.33 at 678 nm. Marks are recorded then read back under the same conditions as in example 30. A signal parameter l8 pp/l8H of 0.42 is obtained.

1. An optical recording medium comprising a substrate, a recording layer and optionally one or more reflecting layers, wherein the recording layer comprises a compound of formula 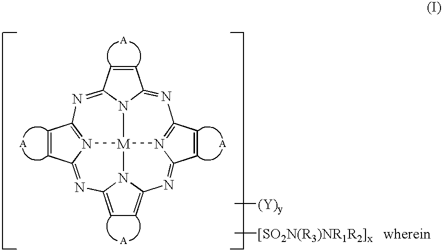
M denotes 2 hydrogen atoms or a 2- to 4-valent metal which can optionally be coordinated or bonded to 1 or 2 additional ligands;
each A independently of the others is an unsaturated divalent radical which may be unsubstituted or mono- or poly-substituted by Y and/or by SO₂N(R₃)NR₁R₂ and together with the two carbon atoms of the fused-on porphyrazine moiety forms an aromatic homo- or N-hetero-cyclic ring system;
each Y independently of all others is halogen, R₄, OH, OR₄, SR₄, NO₂, NR₄R₅, O—CO—R₄, NR₄—CO—R₅, CN, COOR₄, CONHR₄, CONR₄R₅, CO—R₄, SO₂R₄, SO₂NH₂, SO₂NHR₄, SO₂NR₄R₅, P(═O)R₄R₅, PO(R₄)OR₅, PO(OR₄)OR₅, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₇;
R₁ is hydrogen, COOR₄, CONHR₄, CONR₄R₅, CO—R₄, SO₂R₄, P(═O)R₄R₅, PO(R₄)OR₅, PO(OR₄)OR₅, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₇;
R₂ and R₃ are each independently of the other hydrogen or R₈;
R₄, R₅ and R₈ are each independently of the others C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₇;
R₆ is halogen, hydroxy, O—R₉, O—CO—R₉, S—R₉, CO—R⁹, cyano, carboxy, carbamoyl, COO—R⁹, CONH—R⁹, CONR₉R₁₀, SO₂R₉ or SO₃R₉;
R₇ is halogen, nitro, cyano, hydroxy, R₁₁, C(R₁₂)═CR₁₃R₁₄, O—CO—R₁₅, formyl, NR₁₅R₁₆, CONH₂, CONHR₁₅, CONR₁₅R₁₆, SO₂R₁₅, SO₂NH₂, SO₂NHR₁₅, SO₂NR₁₅R₁₆, COOH, COOR₁₅, OCOOR₁₅, NHCOR₁₅, NR₁₅COR₁₇, NHCOOR₁₅, NR₁₅COOR₁₇, P(═O)R₁₅R₁₇, P(═O)R₁₅OR₁₇, P(═O)OR₁₅OR₁₇, or C₁-C₁₂alkyl, C₃-C₁₂cycloalkyl, C₂-C₁₂alkenyl, C₃-C₁₂cycloalkenyl, C₁-C₁₂alkylthio, C₃-C₁₂cycloalkylthio, C₂-C₁₂alkenylthio, C₃-C₁₂cycloalkenylthio, C₁-C₁₂alkoxy, C₃-C₁₂cycloalkoxy, C₂-C₁₂alkenyloxy or C₃-C₁₂cycloalkenyloxy each unsubstituted or substituted by one or more, where applicable identical or different, radicals R₆;
R⁹ and R₁₀ are each independently of the other C₁-C₁₂alkyl, C₃-C₁₂cycloalkyl, C₂-C₁₂alkenyl, C₃-C₁₂cycloalkenyl, C₆-C₁₄aryl, C₄-C₁₂heteroaryl, C₇-C₁₈aralkyl or C₅-C₁₆heteroaralkyl; or
R₉ and R₁₀ together with the common N are pyrrolidine, piperidine, piperazine or morpholine each unsubstituted or mono- to tetra-substituted by C₁-C₄alkyl;
R₁₁ is C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₁₈;
R₁₂ is hydrogen, cyano, halogen, nitro, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals, or C₆-C₁₄aryl, C₄-C₁₂heteroaryl, C₇-C₁₈aralkyl or C₅-C₁₆heteroaralkyl each unsubstituted or substituted by one or more, where applicable identical or different, radicals R₆ and/or by nitro;
R₁₃ and R₁₄ are each independently of the other NR₁₅R₁₆, CN, CONH₂, CONHR₁₅, CONR₁₅R₁₆ or COOR₁₆;
R₁₅, R₁₆ and R₁₇ are each independently of the others R₁₁, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, halogen, hydroxy, C₁-C₁₂alkoxy or C₃-C₁₂cycloalkoxy radicals; or R₁₅ and R₁₆ together with the common N are pyrrolidine, piperidine, piperazine or morpholine each unsubstituted or mono- to tetra-substituted by C₁-C₄alkyl; or carbazole, phenoxazine or phenothiazine each unsubstituted or substituted by one or more, where applicable identical or different, radicals R₁₈;
R₁₈ is nitro, SO₂NHR₉, SO₂NR₉R₁₀, or C₁-C₁₂alkyl, C₃-C₁₂cycloalkyl, C₁-C₁₂alkylthio, C₃-C₁₂cycloalkylthio, C₁-C₁₂alkoxy or C₃-C₁₂cycloalkoxy each substituted by one or more, where applicable identical or different, radicals R₆; and
x is a number from 1 to 8, preferably from 2 to 4, and y is a number from 0 to 15, the sum x+y being a number from 1 to 16;
wherein from 2 to 10 identical or different radicals of formula (I) can be bonded to one another by one or more additional bonds between two or more identical or different R₁, R₂, R₃ or Y, so that dimers, trimers or oligomers having from 4 to 10 phthalocyanine units are formed.

2. An optical recording medium according to claim 1, wherein in formula (I)
A is 1,4-butadienylene;
M denotes 2 hydrogen atoms, Mg, Al, Si, Ti, V, Cr, Mn, Fe, Co, Ni, Cu, Zn, Zr, Mo, Pd, Sn, Hf, Pt or Pb, optionally coordinated or bonded to 1 or 2 additional ligands, depending upon valency;
Y is hydrogen, bromine, iodine, OR₄, NO₂, CN, unsubstituted C₁-C₁₂alkyl, C₃-C₁₂cycloalkyl or C₂-C₁₂alkenyl, or C₆-C₁₀aryl or C₇-C₁₂aralkyl each unsubstituted or substituted by one or more,
where applicable identical or different, radicals R₇;
R₁ is COOR₄, CONHR₄, CONR₄R₅, CO—R₄, SO₂R₄, or C₆-C₁₀aryl, C₄-C₈heteroaryl or C₇-C₁₂aralkyl each unsubstituted or substituted by R₇;
R₂ and R₃ are each independently of the other hydrogen or R₈;
R₄, R₅ and R₈ are each independently of the others C₃-C₈alkyl, C₃-C₈cycloalkyl or C₃-C₈alkenyl each unsubstituted or substituted by R₈, or C₆-C₁₀aryl or C₇-C₁₂aralkyl each unsubstituted or substituted by R₇;
R₈ is halogen, hydroxy, O—R₉, O—CO—R₉, CO—R⁹, cyano or SO₂R₉;
R₇ is halogen, nitro, cyano, O—CO—R₁₅, NR₁₅R₁₆, CONHR₁₅, CONR₁₅R₁₆, SO₂R₁₅, SO₂NH₂, SO₂NHR₁₅, SO₂NR₁₅R₁₆, COOH, COOR₁₅, NHCOR₁₅, NR₁₅COR₁₇, or unsubstituted or substituted C₁-C₁₂alkyl, C₃-C₁₂cycloalkyl, C₁-C₁₂alkoxy or C₃-C₁₂cycloalkoxy;
R₉ and R₁₀ are each independently of the other C₁-C₈alkyl, C₃-C₆cycloalkyl, C₂-C₈alkenyl, C₃-C₆cycloalkenyl or phenyl;
R₉ and R₁₀ together with the common N are pyrrolidine, piperidine, piperazine or morpholine each unsubstituted or mono- to tetra-substituted by C₁-C₄alkyl;
R₁₅, R₁₆ and R₁₇ are each independently of the others C₁-C₈alkyl, C₅-C₆cycloalkyl, C₂-C₈alkenyl or C₅-C₆cycloalkenyl each unsubstituted or substituted by one or more, where applicable identical or different, halogen, hydroxy or C₁-C₄alkoxy radicals, or phenyl or benzyl each unsubstituted or substituted by one or more, where applicable identical or different, halogen, nitro, C₁-C₈alkyl or C₁-C₄alkoxy radicals;
R₁₅ and R₁₆ together with the common N are pyrrolidine, piperidine, piperazine or morpholine each unsubstituted or mono- to tetra-substituted by C₁-C₄alkyl; and/or
x is a number from 1 to 4, and y is a number from 0 to 4,
wherein from 2 to 5 identical or different radicals of formula (I) can be bonded to one another by one or more additional bonds between two or more identical or different R₁, R₂, R₃ or Y, so that dimers, trimers or oligomers having 4 or 5 phthalocyanine units are formed.

3. An optical recording medium according to claim 1, wherein in formula (I)
M is Co(II), Ni(II), Cu(II), Zn(II), Sn(II) or Pb(II);
Y is hydrogen, bromine or OR₄, very especially hydrogen;
R₁ is COOR₄, CONHR₄, CONR₄R₅, CO—R₄, SO₂R₄, or unsubstituted or substituted phenyl or C₇-C₁₂aralkyl, very especially CO—R₄, SO₂R₄ or unsubstituted or substituted phenyl or C₇-C₁₂aralkyl;
R₂ and R₃ are each independently of the other hydrogen or C₁-C₁₂alkyl;
R₄, R₅ and R₈ are each independently of the others C₃-C₈alkyl unsubstituted or substituted by R₆, or phenyl unsubstituted or substituted by R₇;
R₈ is halogen, hydroxy, O—R₉, O—CO—R₉, CO—R⁹, cyano or SO₂R₉;
R₇ is halogen, nitro, cyano, O—CO—R₁₅, NR₁₅R₁₆, or C₁-C₁₂alkyl, C₃-C₁₂cycloalkyl, C₁-C₁₂alkoxy or C₃-C₁₂cycloalkoxy each unsubstituted or substituted by R₆;
R₉ and R₁₀ are each independently of the other C₁-C₄alkyl or phenyl;
R₉ and R₁₀ together with the common N are piperidine or morpholine each unsubstituted or mono- to tetra-substituted by C₁-C₂alkyl;
R₁₅, R₁₆ and R₁₇ are each independently of the others C₁-C₄alkyl unsubstituted or substituted by one or more, where applicable identical or different, halogen, hydroxy or C₁-C₄alkoxy radicals; and/or
R₁₅ and R₁₆ together with the common N are piperidine or morpholine each unsubstituted or mono- to tetra-substituted by C₁-C₄alkyl.

4. An optical recording medium according to claim 1, wherein the recording layer contains from 1 to 100% by weight of the compound of formula (I) or of a mixture of compounds of formula (I).

5. An optical recording medium according to claim 1, wherein substrate, recording layer, reflector layer and, if present, covering layer are arranged in that order.

6. An optical recording medium according to claim 1, additionally comprising a covering layer, wherein substrate, reflector layer, recording layer and covering layer are arranged in that order.

7. An optical recording medium according to claim 1, wherein the recording layer has marks of different lengths, the shortest of which are almost circular and the longest of which are of a length corresponding to approximately four times the width.

8. A method of recording or playing back data, wherein the data on an optical recording medium according to claim 1, are recorded or played back at a wavelength of from 300 to 500 nm.

9. A method according to claim 8, wherein the recording takes place at a linear speed v of at least 4.8 m·s⁻¹ and an output P of at most [v/0.1 m·s⁻¹]^{1/2} mW.

10. (canceled)

11. An optical recording medium comprising a substrate having depressions, a recording layer and optionally one or more reflecting layers, wherein the recording layer has a thickness of from 30 to 80 nm in the depressions and a thickness of from 20 to 70 nm next to the depressions, the difference between the layer thickness in the depressions and the layer thickness next to the depressions being a maximum of 20 nm, preferably a maximum of 10 nm.

12. An optical recording medium according to claim 11, wherein the recording layer comprises a compound of formula (I) according to claim 1.

13. A method of recording or playing back data, wherein marks of different reflectivity are created or read on an optical recording medium according to claim 11 using a laser beam.

14. A method according to claim 13, wherein the marks are of lower reflectivity.

15. A method according to claim 13, wherein the laser beam is directed through the substrate into the depressions of the recording layer.

16. A method according to claim 13, wherein the laser beam has a wavelength of from 300 to 500 nm.

17. An optical recording medium according to claim 2, wherein in formula (I)
M is Co(II), Ni(II), Cu(II), Zn(II), Sn(II) or Pb(II);
Y is hydrogen, bromine or OR₄, very especially hydrogen;
R₁ is COOR₄, CONHR₄, CONR₄R₅, CO—R₄, SO₂R₄, or unsubstituted or substituted phenyl or C₇-C₁₂aralkyl, very especially CO—R₄, SO₂R₄ or unsubstituted or substituted phenyl or C₇-C₁₂aralkyl;
R₂ and R₃ are each independently of the other hydrogen or C₁-C₁₂alkyl;
R₄, R₅ and R₈ are each independently of the others C₃-C₈alkyl unsubstituted or substituted by R₆, or phenyl unsubstituted or substituted by R₇;
R₆ is halogen, hydroxy, O—R₉, O—CO—R₉, CO—R⁹, cyano or SO₂R₉;
R₇ is halogen, nitro, cyano, O—CO—R₁₅, NR₁₅R₁₆, or C₁-C₁₂alkyl, C₃-C₁₂cycloalkyl, C₁-C₁₂alkoxy or C₃-C₁₂cycloalkoxy each unsubstituted or substituted by R₈;
R₉ and R₁₀ are each independently of the other C₁-C₄alkyl or phenyl;
R₉ and R₁₀ together with the common N are piperidine or morpholine each unsubstituted or mono- to tetra-substituted by C₁-C₂alkyl;
R₁₅, R₁₆ and R₁₇ are each independently of the others C₁-C₄alkyl unsubstituted or substituted by one or more, where applicable identical or different, halogen, hydroxy or C₁-C₄alkoxy radicals; and/or
R₁₅ and R₁₆ together with the common N are piperidine or morpholine each unsubstituted or mono- to tetra-substituted by C₁-C₄alkyl.

18. An optical recording medium according to claim 3, wherein in formula (I) M is Cu(II).

19. An optical recording medium according to claim 17, wherein in formula (I) M is Cu(II).

20. An optical recording medium according to claim 1, wherein the recording layer contains from 20 to 100% by weight of the compound of formula (I) or of a mixture of compounds of formula (I).
